(19) United States
(12) Patent Application Publication
(10) Pub. No.: US 2023/0187657 A1
(43) Pub. Date: Jun. 15, 2023

(54) CARRIER-NANOPARTICLE COMPLEX, CATALYST COMPRISING SAME, ELECTROCHEMICAL BATTERY COMPRISING CATALYST, AND METHOD FOR PRODUCING CARRIER-NANOPARTICLE COMPLEX

(71) Applicant: LG CHEM, LTD., Seoul (KR)

(72) Inventors: Wonkyun LEE, Daejeon (KR); Sang Hoon KIM, Daejeon (KR); Gyo Hyun HWANG, Daejeon (KR); Jun Yeon CHO, Daejeon (KR); Kwanghyun KIM, Daejeon (KR); Ran CHOI, Daejeon (KR)

(73) Assignee: LG CHEM, LTD., Seoul (KR)

(21) Appl. No.: 18/106,746

(22) Filed: Feb. 7, 2023

Related U.S. Application Data
(63) Continuation of application No. 16/644,116, filed on Mar. 3, 2020.

(30) Foreign Application Priority Data
Sep. 19, 2017 (KR) 10-2017-0120373
Aug. 31, 2018 (KR) 10-2018-010391

(51) Int. Cl. H01M 4/90; H01M 8/103; H01M 8/1032

(52) U.S. Cl. CPC H01M 4/9075; H01M 4/9041; H01M 8/103; H01M 8/1032; H01M 2008/1095

(57) ABSTRACT

A carrier-nanoparticle complex, a catalyst including the same, an electrochemical cell including the catalyst, and a method for preparing a carrier-nanoparticle complex.

This application is a Divisional of application Ser. No. 16/644,116, filed on Mar. 3, 2020, which is the U.S. National Phase of PCT International Application No. PCT/KR2018/011021, filed on Sep. 19, 2018, which claims priority of Korean Patent Application No. 10-2017-0120373, filed with the Korean Intellectual Property Office on Sep. 19, 2017, and Korean Patent Application No. 10-2018-0103917, filed with the Korean Intellectual Property Office on Aug. 31, 2018, the entire contents of which are incorporated herein by reference.

### TECHNICAL FIELD

The present specification relates to a carrier-nanoparticle complex exhibiting excellent lifetime properties by preventing temperature change-dependent coarsening of a metal catalyst component without declining electrochemical performance, a catalyst comprising the same, an electrochemical cell comprising the catalyst, and a method for preparing a carrier-nanoparticle complex.

### BACKGROUND ART

Fuel cells are a pollution-free clean energy source to replace existing energy sources, and active researches have been progressed thereon under much attention as a next generation energy source. A basic concept of a fuel cell may be explained by the use of electrons produced by a reaction of hydrogen and oxygen. A fuel cell is defined as a cell having an ability to produce a direct current by directly converting chemical reaction energy of a fuel gas comprising hydrogen and the like and an oxidizer comprising oxygen and the like to electric energy, and, unlike existing cells, produces electricity continuously by supplying fuel and air from the outside. Fuel cells are divided into phosphoric acid-type fuel cells, alkaline-type fuel cells, proton exchange membrane fuel cells, molten carbonate fuel cells, direct methanol fuel cells, solid electrolyte fuel cells and the like depending on the operation condition.

Particularly, a proton exchange membrane fuel cell (PEMFC) has received attention as a portable power source due to its high energy density and usability at room temperature. A proton exchange membrane fuel cell (PEMFC) transfers hydrogen ions generated in an anode to a cathode through a polymer electrolyte membrane and bonds the hydrogen ions with oxygen and electrons to form water, and uses electrochemical energy generated herein.

A proton exchange membrane fuel cell operates at a low temperature, and the efficiency is relatively lower than other fuel cells. Accordingly, in order to increase fuel cell efficiency, platinum-supported carbon is normally prepared as a catalyst and used. In fact, when using a platinum-supported carbon catalyst, outstanding performance is obtained in the properties compared to when using other metal-supported catalysts.

However, in the platinum-supported carbon used as a catalyst for a proton exchange membrane fuel cell electrode, the supported platinum has a size of just a few nanometers (nm) and becomes unstable as an electrochemical reaction progresses, and coarsening of platinum nanoparticles occurs. Such platinum nanoparticle coarsening gradually reduces a platinum nanoparticle surface area required for the reaction, and becomes one reason to decline fuel cell performance.

The coarsening may mean a phenomenon of a catalyst nanoparticle expanding by 150% or greater with respect to an initial particle diameter.

### DISCLOSURE

### Technical Problem

The present specification is directed to providing a carrier-nanoparticle complex, a catalyst comprising the same, an electrochemical cell comprising the catalyst, and a method for preparing a carrier-nanoparticle complex.

### Technical Solution

One embodiment of the present specification provides a carrier-nanoparticle complex comprising a carrier; a metal nanoparticle provided on the carrier; and an intermediate layer provided between some or all of the metal nanoparticles, wherein a part of the metal nanoparticle surface is exposed to the outside, and the intermediate layer comprises a cation-based polymer electrolyte and an anion-based polymer electrolyte.

Another embodiment of the present specification provides a catalyst comprising the carrier-nanoparticle complex.

Another embodiment of the present specification provides an electrochemical cell comprising the catalyst.

Another embodiment of the present specification provides a method for preparing the above-described carrier-nanoparticle complex comprising forming a first polymer layer on a surface of a carrier by mixing the carrier and a first polymer electrolyte solution; forming a metal nanoparticle on the first polymer layer by adding the first polymer layer-formed carrier and a metal precursor to a solvent; and forming a polymer composite membrane on a part or all of a surface of the first polymer layer where the metal nanoparticle is not formed by mixing the first polymer layer and the metal nanoparticle-formed carrier with a second polymer electrolyte solution, wherein the first polymer electrolyte solution is an anion-based or a cation-based, and the second polymer electrolyte solution has a charge opposite to the first polymer electrolyte solution.

### Advantageous Effects

A carrier-nanoparticle complex according to one embodiment of the present specification has an advantage of having excellent nanoparticle dispersibility.

A carrier-nanoparticle complex according to one embodiment of the present specification has an advantage of having excellent thermal stability. Specifically, an advantage of suppressing catalyst particle growth is obtained even under a high temperature environment.

A carrier-nanoparticle complex according to one embodiment of the present specification has excellent intermediate crystallinity, and thereby has an advantage of providing high stability even under a high temperature environment.

A carrier-nanoparticle complex according to one embodiment of the present specification has an advantage of having excellent catalyst activity since the catalyst is exposed to the outside rather than being covered by an intermediate layer.

### DESCRIPTION OF DRAWINGS

FIG. 1 is a diagram schematically showing a principle of electricity generation of a fuel cell.

FIG. 2 is a diagram schematically illustrating a structure of a membrane electrode assembly for a fuel cell.

FIG. 3 is a diagram schematically illustrating one embodiment of a fuel cell according to the present specification.

FIG. 4 is an image measuring a carrier-nanoparticle complex prepared in Example 1 using a transmission electron microscope (TEM).

FIG. 5 is an image measuring a carrier-nanoparticle complex prepared in Example 2 using a transmission electron microscope (TEM).

FIG. 6 is an image measuring a carrier-nanoparticle complex prepared in Example 3 using a transmission electron microscope (TEM).

FIG. 7 is an image measuring a carrier-nanoparticle complex prepared in Comparative Example 1 using a transmission electron microscope (TEM).

FIG. 8 is an image measuring a carrier-nanoparticle complex prepared in Comparative Example 2 using a transmission electron microscope (TEM).

FIG. 9 is an image measuring a carrier-nanoparticle complex prepared in Comparative Example 3 using a transmission electron microscope (TEM).

FIG. 10 is an image measuring a carrier-nanoparticle complex prepared in Comparative Example 4 using a transmission electron microscope (TEM)).

FIG. 11 is a graph showing results of performance tests according to Experimental Example 2.

### REFERENCE NUMERAL

10: Electrolyte Membrane
20, 21: Catalyst Layer
40, 41: Gas Diffusion Layer
50: Cathode
51: Anode
60: Stack
70: Oxidizer Supply Unit
80: Fuel Supply Unit
81: Fuel Tank
82: Pump

### Mode for Disclosure

Hereinafter, the present specification will be described in more detail.

In the present application, a description of a certain member being placed “on” another member comprises not only a case of the one member adjoining the another member but a case of still another member being present between the two members.

In the present application, a description of a certain part “comprising” certain constituents means capable of further comprising other constituents, and does not exclude other constituents unless particularly stated on the contrary.

(Carrier-Nanoparticle Complex)

One embodiment of the present specification provides a carrier-nanoparticle complex comprising a carrier; a nanoparticle provided on the carrier; and an intermediate layer provided between some or all of the nanoparticles, wherein a part of the nanoparticle surface is exposed to the outside, and the intermediate layer comprises a cation-based polymer electrolyte and an anion-based polymer electrolyte.

By comprising the intermediate layer, the carrier-nanoparticle complex according to one embodiment of the present specification suppresses growth of the nanoparticle even with high temperature heat treatment and mitigates aggregation of the nanoparticle, and thereby may increase dispersibility of the nanoparticle.

In one embodiment of the present specification, the nanoparticle is two or more.

The intermediate layer will be described later.

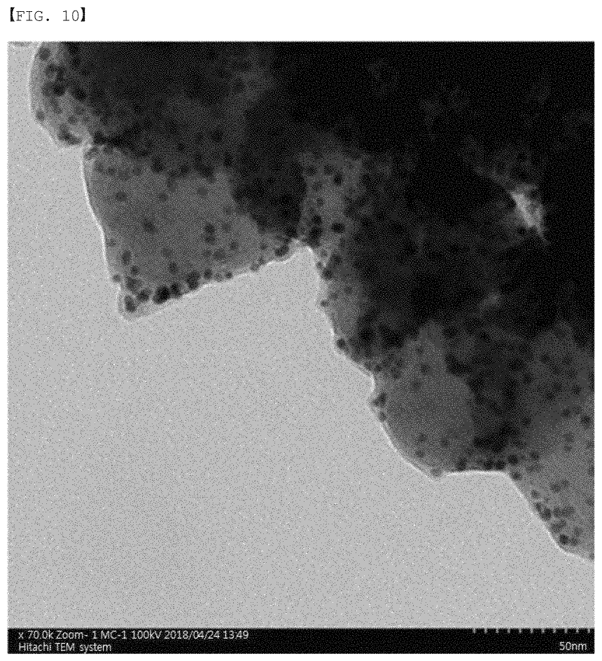

In one embodiment of the present specification, a part of the nanoparticle surface is exposed to the outside. This means a form in which the nanoparticle is not completely covered by the intermediate layer, and when the nanoparticle is completely covered by the intermediate layer, the nanoparticle may not sufficiently perform a function of a catalyst. However, when the nanoparticle is not completely covered by the intermediate layer, and a part of the nanoparticle surface is exposed to the outside, the nanoparticle may sufficiently perform a function of a catalyst. Comparative Example 4 of the present specification relates to a carrier-nanoparticle complex having a form of a nanoparticle being completely covered by an intermediate layer, and a transmission electron microscope (TEM) image is shown in FIG. 10.

In the present specification, a part of the nanoparticle surface being exposed to the outside may be identified by comparing heights of the nanoparticle and the intermediate layer, or through an aperture ratio of the nanoparticle.

In one embodiment of the present specification, a height (h1) of the intermediate layer provided between the nanoparticles is smaller than or the same as an average diameter (d1) of the nanoparticles. When satisfying the above-mentioned condition, the nanoparticle is not covered by the intermediate layer, and a part of the nanoparticle surface may be exposed to the outside. In addition, the above-mentioned condition may be distinguished through a transmission electron microscope (TEM) image of the carrier-nanoparticle complex.

In one embodiment of the present specification, the height (h1) of the intermediate layer provided between the nanoparticles may be from 1% to 99%, preferably from 5% to 70% and more preferably from 10% to 50% based on the average diameter (d1) of the nanoparticles. When satisfying the above-mentioned numerical range, the nanoparticle is not covered by the intermediate layer, and a part of the nanoparticle surface may be exposed to the outside.

In one embodiment of the present specification, the nanoparticle may have an aperture ratio of 50% or greater, preferably 70% or greater, and more preferably 80% or greater. When satisfying the above-mentioned numerical range, the catalyst nanoparticles are present in a state of being opened to the outside, which is advantageous in obtaining excellent catalyst activity.

In the present specification, the “aperture ratio” means a ratio of a total area that is not covered by the intermediate with respect to the total surface area of the nanoparticle, and may be calculated through a transmission electron microscope (TEM) image of the carrier-nanoparticle complex.

(Carrier)

In one embodiment of the present specification, the carrier may comprise one, two or more types selected from the group consisting of carbon black, carbon nanotubes (CNT), graphite, graphene, activated carbon, mesoporous carbon, carbon fiber and carbon nanowires.

In one embodiment of the present specification, the carrier may have a particle size of 50 nm to 10=m.

In one embodiment of the present specification, the carrier particle shape may be one, two or more selected from the group consisting of a spherical-type, a cylindrical-type, a plate-type and a bar-type.

In the present specification, the polymer electrolyte may mean a polymer having a charge. Specifically, the polymer electrolyte may comprise a synthetic polymer having a charge, an ion exchange resin or the like. In addition, the cation-based polymer electrolyte is a cationic polymer electrolyte comprising a cationic polymer, and the anion-based polymer electrolyte is an anionic polymer electrolyte comprising an anionic polymer.

In one embodiment of the present specification, the cation-based polymer electrolyte may comprise one or two of a polymer having an amine group and a polymer having a pyridine group. Herein, the amine group or the pyrimidine group may induce nanoparticle bonding. Accordingly, dispersibility of the nanoparticle may increase by mitigating aggregation of the nanoparticle.

In one embodiment of the present specification, the polymer having an amine group may comprise at least any one of polyalkyleneimine and polyallylamine hydrochloride (PAH).

In one embodiment of the present specification, the polymer having an amine group may have a weight average molecular weight of 500 to 1,000,000, preferably 5,000 to 500,000, and more preferably 10,000 to 100,000. When satisfying the above-mentioned range, cohesion of the cationic polymer may be properly controlled and coat-ability for the carrier is excellent, and therefore, there is an advantage in that a polymer layer having a uniform thickness may be formed when coated on the carrier surface.

In one embodiment of the present specification, the polyalkyleneimine may comprise at least one of a repeating unit represented by the following Chemical Formula 1 and a repeating unit represented by the following Chemical Formula 2.

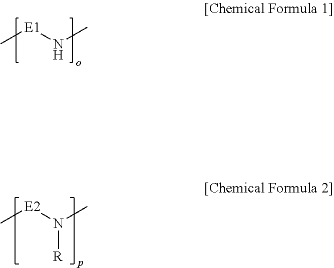

In Chemical Formula 1 and Chemical Formula 2, E1 and E2 are each independently an alkylene group having 2 to 10 carbon atoms, R is a substituent represented by any one of the following Chemical Formulae 3 to 5, and o and p are each an integer of 1 to 1000,

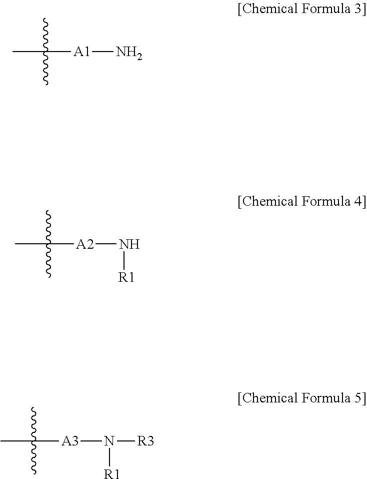

in Chemical Formulae 3 to 5, A1 to A3 are each independently an alkylene group having 2 to 10 carbon atoms, and R1 to R3 are each independently a substituent represented by any one of the following Chemical Formulae 6 to 8,

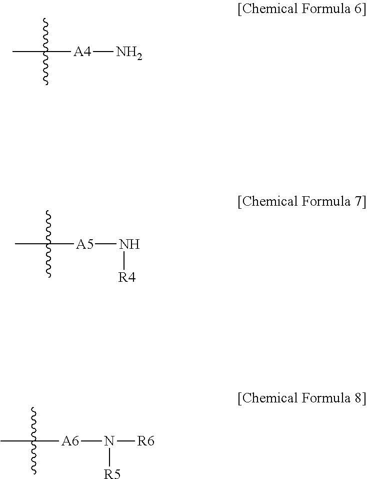

in Chemical Formulae 6 to 8, A4 to A6 are each independently an alkylene group having 2 to 10 carbon atoms, and R4 to R6 are the same as or different from each other and each independently a substituent represented by the following Chemical Formula 9,

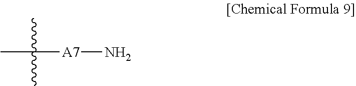

In Chemical Formula 9, A7 is an alkylene group having 2 to 10 carbon atoms.

In one embodiment of the present specification, the polyalkyleneimine may comprise at least one of a compound represented by the following Chemical Formula 10 and a compound represented by the following Chemical Formula 11.

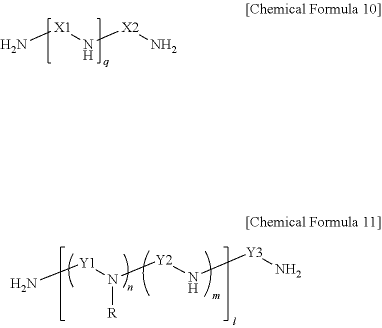

In Chemical Formulae 10 and 11, X1, X2, Y1, Y2 and Y3 are each independently an alkylene group having 2 to 10 carbon atoms, R is a substituent represented by any one of the following Chemical Formulae 3 to 5, q is an integer of 1 to 1000, n and m are each an integer of 1 to 5, and 1 is an integer of 1 to 200,

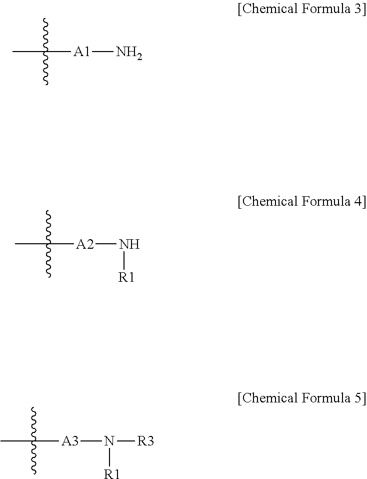

in Chemical Formulae 3 to 5, A1 to A3 are each independently an alkylene group having 2 to 10 carbon atoms, R1 to R3 are each independently a substituent represented by any one of the following Chemical Formulae 6 to 8,

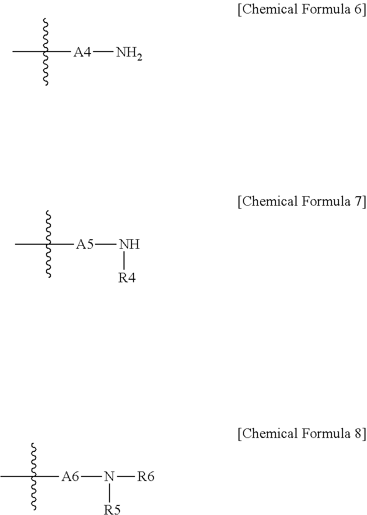

in Chemical Formulae 6 to 8, A4 to A6 are each independently an alkylene group having 2 to 10 carbon atoms, and R4 to R6 are each independently a substituent represented by the following Chemical Formula 9,

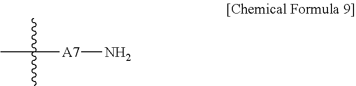

In Chemical Formula 9, A7 is an alkylene group having 2 to 10 carbon atoms.

In the present specification,

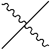

means a position of substitution of a substituent.

In the present specification, the alkylene group may be linear or branched, and although not particularly limited thereto, the number of carbon atoms is preferably from 2 to 10. Specific examples thereof may comprise an ethylene group, a propylene group, an isopropylene group, a butylene group, a t-butylene group, a pentylene group, a hexylene group, a heptylene group and the like, but are not limited thereto.

In one embodiment of the present specification, the polymer having a pyridine group may be any one or more selected from the group consisting of polypyridine and polyvinylpyridine.

In one embodiment of the present specification, the polymer having a pyridine group may have a weight average molecular weight of 500 to 1,000,000, preferably 5,000 to 500,000, and more preferably 10,000 to 100,000. When satisfying the above-mentioned range, cohesion of the cationic polymer may be properly controlled and coat-ability for the carrier is excellent, and therefore, there is an advantage in that a polymer layer having a uniform thickness may be formed when coated on the carrier surface.

In one embodiment of the present specification, the anion-based polymer electrolyte comprises an anionic polymer, and the anionic polymer may be a polymer having a sulfone group.

In one embodiment of the present specification, the anionic polymer may have a weight average molecular weight of 500 to 1,000,000, preferably 5,000 to 500,000, and more preferably 10,000 to 100,000. When satisfying the above-mentioned range, cohesion of the anionic polymer may be properly controlled and coat-ability for the carrier is excellent, and therefore, there is an advantage in that a polymer layer having a uniform thickness may be formed when coated on the carrier surface.

In one embodiment of the present specification, the polymer having a sulfone group may be polystyrene sulfonate or polyvinylsulfonic acid.

In one embodiment of the present specification, the polymer having a sulfone group may be poly(4-styrenesulfonic acid).

(Nanoparticle)

In the present specification, the “nanoparticle” means a particle having an average particle diameter of a few to tens of nanometers (nm).

In the present specification, the “nanoparticle” may be a “metal nanoparticle”, a metal material.

In one embodiment of the present specification, the nanoparticle may comprise one, two or more metals selected from the group consisting of platinum (Pt), ruthenium (Ru), rhodium (Rh), molybdenum (Mo), osmium (Os), iridium (Ir), rhenium (Re), palladium (Pd), vanadium (V), tungsten (W), cobalt (Co), iron (Fe), selenium (Se), nickel (Ni), bismuth (Bi), tin (Sn), chromium (Cr), titanium (Ti), gold (Au), cerium (Ce), silver (Ag) and copper (Cu). Specifically, the nanoparticle may comprise platinum (Pt); and a platinum alloy allying platinum (Pt) with iron (Fe), cobalt (Co), nickel (Ni), palladium (Pd), rhodium (Rh) or ruthenium (Ru).

In one embodiment of the present specification, the nanoparticle may have an average particle diameter of greater than or equal to 2 nm and less than or equal to 20 nm, and specifically greater than or equal to 3 nm and less than or equal to 10 nm. In this case, the nanoparticles on the carrier do not aggregate with each other and exhibit high dispersibility, which are advantages in obtaining high catalyst efficiency.

Herein, the average particle diameter of the nanoparticle means an average of lengths of a longest line among lines connecting two points on the nanoparticle surface, and for example, may mean an average of lengths of a longest line among lines connecting two points on the nanoparticle surface in an image measured using a transmission electron microscope.

In one embodiment of the present specification, the nanoparticle may have a spherical shape. In the present specification, a spherical shape not only means a completely sphere, but may also comprise shapes that are roughly spherical in the shape. For example, the nanoparticle may not have a smooth spherical-shaped outer surface, and the radius of curvature may not be constant in one nanoparticle.

In one embodiment of the present specification, the nanoparticle may be selected from among a solid particle comprising one type of a metal, a solid particle comprising two or more types of metals, a core-shell particle comprising two or more types of metals, a hollow metal particle comprising one, two or more types of metals, a bowl-type particle comprising one, two or more types of metals, a yolk-shell particle comprising two or more types of metals, and a porous particle comprising one, two or more types of metals.

In one embodiment of the present specification, the content of the nanoparticle may be greater than or equal to 15% by weight and less than or equal to 50% by weight with respect to the total weight of the carrier-nanoparticle complex. Specifically, the content of the nanoparticle may be greater than or equal to 20% by weight and less than or equal to 40% by weight with respect to the total weight of the carrier-nanoparticle complex.

(Intermediate Layer)

In one embodiment of the present specification, the carrier-nanoparticle complex comprises an intermediate layer provided between some or all of the metal nanoparticles.

In one embodiment of the present specification, the intermediate layer may be provided in some or all of empty space between the nanoparticles by being provided on a part or the entire surface of the carrier not provided with the metal nanoparticles. Accordingly, coarsening, a phenomenon of the nanoparticle growing, may be suppressed not to occur even when the nanoparticles become unstable with the progress of an electrochemical reaction, and through such structural stability, thermal and structural stability of a catalyst may be enhanced, fuel cell performance decline may be minimized, and lifetime properties may be enhanced.

In one embodiment of the present specification, the intermediate layer may be provided on greater than or equal to 50% and less than or equal to 100%, and preferably on greater than or equal to 70% and less than or equal to 100% based on the total area of the surface of the carrier not provided with the metal nanoparticles. When satisfying the above-mentioned numerical range, nanoparticle growth may be effectively prevented, and performance may be stably maintained even at a high temperature. The ratio may be calculated through the following process. Using a scanning electron microscope or a transmission electron microscope, a total area of the carrier surface, a total area of the carrier surface occupied by the nanoparticles, and a total area of the carrier surface occupied by the intermediate layer are calculated. From a difference between the total area of the carrier surface and the total area of the carrier occupied by the nanoparticles, a total area of the carrier to which the nanoparticles are not introduced is calculated.

After that, the ratio may be derived from {(area of carrier surface occupied by intermediate layer)/(total area of carrier to which nanoparticles are not introduced)*100(%)}.

The intermediate layer may comprise a cation-based polymer electrolyte and an anion-based polymer electrolyte.

The cation-based polymer electrolyte and the anion-based polymer electrolyte strongly bond due to electrostatic attraction between them, and may form a structurally stable intermediate layer. Accordingly, there is an advantage in that structural stability of the intermediate layer is excellent compared to when simply providing a compound and the like suppressing nanoparticle growth between nanoparticles.

In addition, by the polymer comprising electrolytes having different charges, electrostatic attraction between them is high compared to when comprising electrolytes having the same type of charges, which is effective in obtaining excellent polymer durability and the size being not changed too much, and as a result, an advantage of effectively suppressing growth of the supported catalyst is obtained even with heat treatment at a high temperature.

In one embodiment of the present specification, the intermediate layer may either comprise a cation-based polymer electrolyte and an anion-based polymer electrolyte consecutively laminated from the carrier side, or comprise an anion-based polymer electrolyte and a cation-based polymer electrolyte consecutively laminated from the carrier side.

The electrostatic attraction may control ionic bond strength between polymer electrolytes by diversely using cation-based polymer electrolyte and anion-based polymer electrolyte types.

In one embodiment of the present specification, the intermediate layer has excellent bonding strength with the carrier.

In one embodiment of the present specification, the intermediate layer is formed by strong electrostatic attraction between the cation-based polymer electrolyte and the anion-based polymer electrolyte, and has an advantage of being selectively formed in empty space between the nanoparticles instead of on the nanoparticle surface. In other words, unlike an intermediate layer with no attraction between polymer electrolytes such as simply disposing a compound with no charges or disposing compounds having the same charge, attraction between the polymer electrolytes of the intermediate layer is high, and crystallinity of the intermediate layer itself is excellent.

In one embodiment of the present specification, the intermediate layer may further comprise carbon. In addition, the carbon included in the intermediate layer may be obtained by carbonizing the polymer electrolyte comprising the cation-based polymer electrolyte and the anion-based polymer electrolyte. When the intermediate layer further comprises carbon, crystallinity of the intermediate is excellent resulting in higher stability even under a high temperature environment.

In one embodiment of the present specification, the polymer electrolyte and the carbon may have a weight ratio of 1:99 to 99:1, and preferably 1:99 to 70:30. When satisfying the above-mentioned range, the intermediate layer has excellent crystallinity, and aggregation of the catalyst particles caused by the particles moving to each other may be effectively suppressed by securing a stable supporting site, and the metal catalyst particles may be highly dispersed.

Descriptions on the carbonation will be provided later.

In one embodiment of the present specification, the intermediate layer has a thickness of 0.1 nm to 10 nm, and preferably 0.3 nm to 5 nm. When satisfying the above-mentioned numerical range, nanoparticle growth may be effectively suppressed, and diffusion between materials is not inhibited as well.

(Method for Preparing Carrier-Nanoparticle Complex)

One embodiment of the present specification provides a method for preparing the above-described carrier-nanoparticle complex comprising forming a first polymer layer on a surface of a carrier by mixing the carrier and a first polymer electrolyte solution; forming a metal nanoparticle on the first polymer layer by adding the first polymer layer-formed carrier and a metal precursor to a solvent; and forming a polymer composite membrane on a part or all of a surface of the first polymer layer where the metal nanoparticle is not formed by mixing the first polymer layer and the metal nanoparticle-formed carrier with a second polymer electrolyte solution, wherein the first polymer electrolyte solution is an anion-based or a cation-based, and the second polymer electrolyte solution has a charge opposite to the first polymer electrolyte solution.

The method for preparing a carrier-nanoparticle complex comprises forming a first polymer layer on a surface of a carrier.

In one embodiment of the present specification, the first polymer layer may be formed on greater than or equal to 50% and less than or equal to 100%, and preferably greater than or equal to 70% and less than or equal to 100% of the carrier surface.

In one embodiment of the present specification, the forming of a polymer composite membrane comprises forming a second polymer layer on a part or all of a surface of the first polymer layer where the nanoparticle is not formed.

The first polymer electrolyte solution of the first polymer layer and the second polymer electrolyte solution of the second polymer layer are each a cation-based or an anion-based, and have charges opposite to each other, and therefore, strong electrostatic attraction is present between them. As a result, the second polymer layer is attracted to the first polymer layer when formed, and the second polymer layer is selectively formed on the first polymer layer.

In the present specification, the “polymer composite membrane” may mean a laminate in which the first polymer layer and the second polymer layer formed on the first polymer layer bond to each other through strong electrostatic attraction.

In one embodiment of the present specification, the method for preparing a carrier-nanoparticle complex may comprise preparing a first polymer electrolyte solution by adding a cationic polymer or an anionic polymer to a first solvent, and stirring the result.

The first polymer electrolyte solution has a charge opposite to the second polymer electrolyte to describe later, and is introduced to effectively form an intermediate layer by strongly bonding to the second polymer electrolyte through electrostatic attraction.

The first polymer electrolyte solution may further comprise a salt. The salt may be an alkali metal nitrate, and specifically, the salt may at least one of KNO₃, NaNO₃ and Ca(NO₃)₂.

In one embodiment of the present specification, the first solvent included in the first polymer electrolyte solution is not particularly limited, and may comprise at least one of water, ethanol, 2-propanol and iso-propanol.

In one embodiment of the present specification, the content of the carrier may be greater than or equal to 0.05% by weight and less than or equal to 20% by weight based on the total weight of the first polymer electrolyte solution.

In one embodiment of the present specification, the content of the cationic polymer or the anionic polymer may be greater than or equal to 0.05% by weight and less than or equal to 20% by weight based on the total weight of the first polymer electrolyte solution.

In one embodiment of the present specification, the content of the salt may be greater than or equal to 0.05% by weight and less than or equal to 20% by weight based on the total weight of the first polymer electrolyte solution.

In one embodiment of the present specification, the content of the first solvent may be greater than or equal to 40% by weight and less than or equal to 99.85% by weight based on the total weight of the first polymer electrolyte solution.

In one embodiment of the present specification, the time of stirring the first polymer electrolyte solution may be longer than or equal to 3 hours and shorter than or equal to 72 hours.

In one embodiment of the present specification, the method for preparing a carrier-nanoparticle complex comprises forming a nanoparticle on the first polymer layer of the carrier by adding the first polymer layer-formed carrier and a metal precursor to a solvent.

In one embodiment of the present specification, the forming of a nanoparticle may comprise preparing a third solution comprising the first polymer layer-formed carrier, a metal precursor and a third solvent; stirring the third solution; and forming a nanoparticle by reducing the metal precursor.

The metal precursor is a material prior to being reduced to a nanoparticle, and the metal precursor may be selected depending on a nanoparticle type.

Types of the metal precursor are not limited, however, the metal precursor is a salt comprising a metal ion or an atomic group ion comprising the metal ion, and may perform a role of providing a metal. The metal precursor may comprise, depending on a metal component of a nanoparticle to prepare, one or more metal precursors having different metal ions or atomic group ions.

The solvent of the third solution may comprise water or polyalcohol comprising two or more hydroxyl groups. The polyalcohol is not particularly limited as long as it has two or more hydroxyl groups, and may comprise at least one of ethylene glycol, diethylene glycol and propylene glycol.

The third solution for forming a nanoparticle on the first polymer layer of the carrier does not comprise a surfactant. This has advantages in that a step of removing a surfactant does not have to be further performed after synthesizing the catalyst, and there is no active site decrease caused by the surfactant.

In one embodiment of the present specification, the third solution may further comprise a stabilizer. The stabilizer is not particularly limited, and examples thereof may comprise one selected from the group consisting of disodium phosphate, dipotassium phosphate, sodium citrate, disodium citrate and trisodium citrate, or mixtures of two or more thereof.

In one embodiment of the present specification, the content of the first polymer layer-formed carrier may be greater than or equal to 0.1% by weight and less than or equal to 3% by weight based on the total weight of the third solution.

In one embodiment of the present specification, the content of the metal precursor may be greater than or equal to 0.1% by weight and less than or equal to 4% by weight based on the total weight of the third solution.

In one embodiment of the present specification, the content of the stabilizer may be greater than or equal to 0.1% by weight and less than or equal to 4% by weight based on the total weight of the third solution.

In one embodiment of the present specification, the content of the third solvent may be greater than or equal to 93% by weight and less than or equal to 98% by weight based on the total weight of the third solution.

In one embodiment of the present specification, the method for forming a carrier-nanoparticle complex may further comprise removing the third solvent after forming a nanoparticle on the first polymer layer of the carrier. Through the removing of the third solvent, the solvent is removed, and the nanoparticle provided on the first polymer layer of the carrier may be sintered.

In one embodiment of the present specification, the removing of the third solvent may be heat treating under the hydrogen or argon atmosphere. Herein, the heat treatment temperature may be higher than or equal to 180° C. and lower than or equal to 300° C. The heat treatment temperature satisfying the above-mentioned range has advantages of effectively removing the solvent, and preventing the first polymer electrolyte on the carrier surface from being decomposed or deformed.

The method for preparing a carrier-nanoparticle complex according to one embodiment of the present specification comprises forming a polymer composite membrane on a part or all of a surface of the first polymer layer where the nanoparticle is not formed by mixing the carrier and a second polymer electrolyte solution.

In one embodiment of the present specification, the first polymer electrolyte solution is a cation-based or an anion-based, and the second polymer electrolyte solution has a charge opposite to the first polymer electrolyte solution. This means that, when the first polymer electrolyte included in the first polymer electrolyte solution is a cationic polymer electrolyte, the second polymer electrolyte included in the second polymer electrolyte solution is an anionic polymer electrolyte, and when the first polymer electrolyte is an anionic polymer electrolyte, the second polymer electrolyte is a cationic polymer electrolyte.

In one embodiment of the present specification, the cationic polymer electrolyte solution has a pH of 1 to 6 and preferably 1 to 4, and the anionic polymer electrolyte solution has a pH of 1 to 12 and preferably 1 to 10. When satisfying the above-mentioned numerical range, electrostatic attraction caused by a difference in the sign of the charges between the cationic polymer electrolyte and the anionic polymer electrolyte may be maximized.

In one embodiment of the present specification, the cationic polymer electrolyte solution may further comprise an acidic solution. The acidic solution is not particularly limited as long as it is a material releasing hydrogen ions in a solution, and for example, may be an organic acid or an inorganic acid. Examples thereof may comprise, but are not limited to, one or more types selected from the group consisting of formic acid, acetic acid, propionic acid, butyric acid, adipic acid, lactic acid, citric acid, fumaric acid, malic acid, glutaric acid, succinic acid, hydrochloric acid, nitric acid, phosphoric acid, sulfuric acid and boric acid.

In one embodiment of the present specification, the anionic polymer electrolyte solution may further comprise a basic solution. The basic solution is not particularly limited as long as it is a material releasing hydroxide ions in a solution, and examples thereof may comprise, but are not limited to, one or more types selected from the group consisting of sodium hydroxide (NaOH), sodium sulfate (NaSH), sodium azide (NaN₃), potassium hydroxide (KOH), potassium sulfate (KSH) and potassium thiosulfate (KS₂O₃).

In one embodiment of the present specification, the forming of a polymer composite membrane may further comprise preparing a second polymer electrolyte solution comprising a polymer having a charge opposite to the polymer included in the first polymer electrolyte solution and a second solvent; and stirring the second polymer electrolyte solution.

The second solvent is not particularly limited, and may comprise at least one of water, ethanol, 2-propanol and iso-propanol.

Based on the solid content weight of the second polymer electrolyte solution, the content of the cationic polymer or the anionic polymer included in the second polymer electrolyte solution may be greater than or equal to 10% by weight and less than or equal to 90% by weight.

In one embodiment of the present specification, the total content of the solid in the second polymer electrolyte solution excluding the solvent may be greater than or equal to 0.05% by weight and less than or equal to 20% by weight based on the total weight of the second polymer electrolyte solution, and the content of the second solvent may be greater than or equal to 80% by weight and less than or equal to 99.95% by weight based on the total weight of the second polymer electrolyte solution.

In one embodiment of the present specification, the time of stirring the second polymer electrolyte solution may be longer than or equal to 3 hours and shorter than or equal to 72 hours.

In one embodiment of the present specification, the forming of an intermediate layer may further comprise heat treating the polymer composite membrane.

In one embodiment of the present specification, heat treating the polymer composite membrane is included after the forming of a polymer composite membrane.

In one embodiment of the present specification, the heat treating of the polymer composite membrane may further comprise pretreatment of stabilizing the polymer composite membrane. The pretreatment may be performed for a time of 30 minutes to 2 hours at a temperature of 200° C. to 800° C.

In one embodiment of the present specification, the heat treating of the polymer composite membrane may be performed at a temperature of 400° C. to 2000° C., preferably 400° C. to 1600° C., and more preferably 800° C. to 1200° C. The temperature being in the above-mentioned range has an advantage of having excellent strength without damaging the polymer composite membrane by heat treatment.

In one embodiment of the present specification, the heat treating of the polymer composite membrane may be performed for 30 minutes to 120 minutes, preferably for 30 minutes to 90 minutes, and more preferably for 40 minutes to 60 minutes. When the performing time is as mentioned above, the polymer composite membrane may be heat treated without being damaged, and excellent intermediate layer strength is obtained.

In one embodiment of the present specification, the heat treating of the polymer composite membrane may be performed under the inert gas atmosphere such as argon or nitrogen.

In one embodiment of the present specification, the heat treating of the polymer composite membrane may further comprise carbonizing the polymer composite membrane.

In one embodiment of the present specification, the carbonizing of the polymer composite membrane is forming carbon by carbonizing the polymer composite membrane included in the intermediate layer. By properly controlling a performing condition of the carbonizing as follows, a ratio of the polymer composite membrane being carbonized to carbon may be controlled. In other words, a ratio of the polymer electrolyte and the carbon included in the intermediate layer may be controlled.

In one embodiment of the present specification, the carbonizing of the polymer composite membrane may be performed at 800° C. to 2000° C., preferably at 800° C. to 1600° C., and more preferably at 800° C. to 1200° C. When the performing temperature is as mentioned above, a degree of the polymer composite membrane being carbonized increases, and excellent intermediate layer crystallinity is obtained.

In one embodiment of the present specification, the carbonizing of the polymer composite membrane may be performed for 30 minutes to 120 minutes, preferably for 30 minutes to 90 minutes, and more preferably for 40 minutes to 60 minutes. When the performing time is as mentioned above, the polymer composite membrane may be carbonized without being damaged, and excellent intermediate layer crystallinity is obtained.

In one embodiment of the present specification, post treatment is further included after the heat treating of the polymer composite membrane.

In one embodiment of the present specification, the post treatment may be heat treatment or acid treatment.

In one embodiment of the present specification, in the heat treatment, the heat treatment temperature may be higher than or equal to 200° C. and lower than or equal to 800° C.

In one embodiment of the present specification, in the heat treatment, the heat treatment time may be longer than or equal to 30 minutes and shorter than or equal to 3 hours.

In one embodiment of the present specification, in the heat treatment, the heat treatment may be performed under the inert gas atmosphere.

In one embodiment of the present specification, the inert gas may be argon gas.

In one embodiment of the present specification, the heat treatment may use methods commonly used in the art as long as the method satisfies the heat treatment temperature and time and the inert gas atmosphere.

In one embodiment of the present specification, the acid treatment may comprise mixing an acid solution with the nanoparticle-formed carrier-nanoparticle complex, and the acid solution may be one, two or more selected from the group consisting of hydrochloric acid, nitric acid and sulfuric acid.

(Catalyst)

One embodiment of the present specification provides a catalyst comprising the carrier-nanoparticle complex.

In one embodiment of the present specification, the catalyst may further comprise a metal selected from the group consisting of platinum, ruthenium, osmium, a platinum-ruthenium alloy, a platinum-osmium alloy, a platinum-palladium alloy and a platinum-transition metal alloy. The metal may be used by itself, and may also be supported on the carrier to be used.

(Electrochemical Cell)

One embodiment the present specification provides an electrochemical cell comprising the catalyst.

In one embodiment of the present specification, the electrochemical cell means a cell using a chemical reaction, and although the type is not particularly limited as long as it is provided with a polymer electrolyte membrane, examples of the electrochemical cell may comprise a fuel cell, a metal secondary battery or a flow battery.

One embodiment of the present specification provides an electrochemical cell module comprising the electrochemical cell as a unit cell.

In one embodiment of the present specification, the electrochemical cell module may be formed by inserting a bipolar plate between the flow batteries according to one embodiment of the present application, and stacking the result.

In one embodiment of the present specification, the cell module may be used as a power supply of electric vehicles, hybrid electric vehicles, plug-in hybrid electric vehicles or power storage devices.

(Membrane Electrode Assembly)

One embodiment of the present specification provides a membrane electrode assembly comprising an anode catalyst layer, a cathode catalyst layer, and a polymer electrolyte membrane provided between the anode catalyst layer and the cathode catalyst layer, wherein at least one of the anode catalyst layer and the cathode catalyst layer comprises the carrier-nanoparticle complex.

In one embodiment of the present specification, the membrane electrode assembly may further comprise an anode gas diffusion layer provided on a surface opposite the surface provided with the polymer electrolyte membrane of the anode catalyst layer, and a cathode gas diffusion layer provided on a surface opposite to the surface provided with the polymer electrolyte membrane of the cathode catalyst layer.

One embodiment of the present specification provides a fuel cell comprising the membrane electrode assembly.

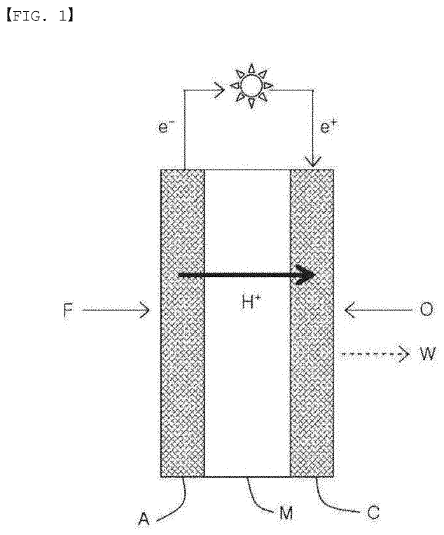

FIG. 1 is a diagram schematically showing a principle of electricity generation of a fuel cell, and in a fuel cell, a most basic unit generating electricity is a membrane electrode assembly (MEA), which is formed with an electrolyte membrane (M), and an anode (A) and a cathode (C) formed on both surfaces of this electrolyte membrane (M). When referring to FIG. 1 showing a principle of electricity generation of a fuel cell, an oxidation reaction of fuel (F) such as hydrogen, methanol or hydrocarbon such as butane occurs in an anode (A) to generate hydrogen ions (H⁺) and electrons (e⁻), and the hydrogen ions migrate to a cathode (C) through an electrolyte membrane (M). In the cathode (C), the hydrogen ions transferred through the electrolyte membrane (M), an oxidizer (O) such as oxygen, and electrons react to produce water (W). Through such a reaction, electrons migrate to an external circuit.

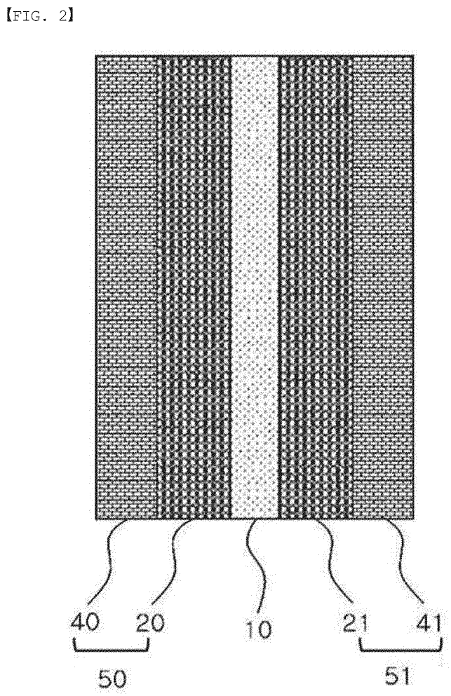

FIG. 2 schematically illustrates a structure of the membrane electrode assembly for a fuel cell, and the membrane electrode assembly for a fuel cell may be provided with an electrolyte membrane (10), and a cathode (50) and an anode (51) placed opposite to each other with this electrolyte membrane (10) in between. In the cathode, a cathode catalyst layer (20) and a cathode gas diffusion layer (40) may be consecutively provided from the electrolyte membrane (10), and in the anode, an anode catalyst layer (21) and an anode gas diffusion layer (41) may be consecutively provided from the electrolyte membrane (10).

In the membrane electrode assembly, the catalyst according to one embodiment of the present specification may be included in at least one of the cathode catalyst layer and the anode catalyst layer.

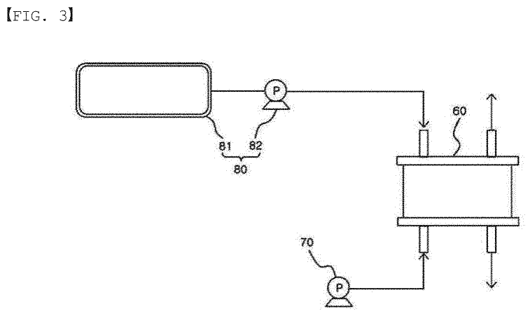

FIG. 3 schematically illustrates a structure of the fuel cell, and the fuel cell is formed comprising a stack (60), an oxidizer supply unit (70) and a fuel supply unit (80).

The stack (60) comprises one, two or more of the membrane-electrode assemblies described above, and when two or more of the membrane-electrode assemblies are included, a separator provided therebetween is included. The separator prevents the membrane-electrode assemblies from being electrically connected, and performs a role of transferring fuel and oxidizer supplied from the outside to the membrane-electrode assemblies.

The oxidizer supply unit (70) performs a role of supplying an oxidizer to the stack (60). As the oxidizer, oxygen is typically used, and oxygen or air may be injected to the oxidizer supply unit (70) to be used.

The fuel supplying unit (80) performs a role supplying a fuel to the stack (60), and may be formed with a fuel tank (81) storing a fuel, and a pump (82) supplying the fuel stored in the fuel tank (81) to the stack (60). As the fuel, hydrogen or hydrocarbon fuel in a gas or liquid state may be used. Examples of the hydrocarbon fuel may comprise methanol, ethanol, propanol, butanol or natural gas.

The anode catalyst layer and the cathode catalyst layer may each comprise an ionomer.

When the anode catalyst layer comprises the carrier-nanoparticle complex, the ionomer and the carrier-nanoparticle complex (complex) in the anode catalyst layer has a ratio (ionomer/complex, I/C) of 0.3 to 0.7.

When the cathode catalyst layer comprises the carrier-nanoparticle complex, the ionomer and the carrier-nanoparticle complex (complex) in the cathode catalyst layer has a ratio (ionomer/complex, I/C) of 0.3 to 0.7.

Considering that a general I/C ratio used in commercial catalysts is from 0.8 to 1 (book “PEM fuel cell electrocatalyst and catalyst layer”, page 895), the ionomer content may be reduced by, based on the ionomer content required for the catalyst layer, 20% by weight or greater, specifically 30% by weight or greater, and more specifically 50% by weight or greater when comprising the carrier-nanoparticle complex according to the present specification as a catalyst. In other words, the content of an expensive ionomer may be reduced, and hydrogen ion conductivity may be maintained at a certain level or higher even with a small ionomer content.

The ionomer performs a role of providing a passage for ions generated from the reaction between fuel such as hydrogen or methanol and a catalyst to migrate to the electrolyte membrane.

As the ionomer, polymers having a cation exchange group selected from the group consisting of a sulfonic acid group, a carboxylic acid group, a phosphoric acid group, a phosphonic acid group and derivatives thereof on the side chain may be used. Specifically, the ionomer may comprise one or more types of hydrogen ion conducting polymers selected from among fluoro-based polymers, benzimidazole-based polymers, polyimide-based polymers, polyetherimide-based polymers, polyphenylene sulfide-based polymers, polysulfone-based polymers, polyethersulfone-based polymers, polyetherketone-based polymers, polyether-etherketone-based polymers or polyphenylquinoxaline-based polymers. Specifically, in one embodiment of the present specification, the polymer ionomer may be Nafion.

Hereinafter, the present specification will be described through the following examples, however, the scope of a right is not limited to the scope of the examples.

### Experimental Example

### Example 1

After dissolving polyallylamine hydrochloride (PAH) (6 g) in water (1.5 L), carbon black (Vulcan XC-72R, manufactured by Cabot Corporation) (1.8 g) and KNO₃ (6 g) were introduced thereto, and the result was stirred for 24 hours. After that, solids were collected using centrifugation, and the solids were washed with distilled water and dried to obtain a PAH-coated carrier.

After dispersing the PAH-coated carrier (70 mg) into water (100 ml), K₂PtCl₄ (41.5 mg), nickel(II) acetate tetrahydrate (49.8 mg) and sodium citrate (294.1 mg) were added to the solution, and then dispersed. After that, while stirring the result in a water bath adjusted to 15° C., sodium borohydride (50 mg) and water (10 ml) were added thereto to reduce the metal precursor and support nickel-platinum alloy particles.

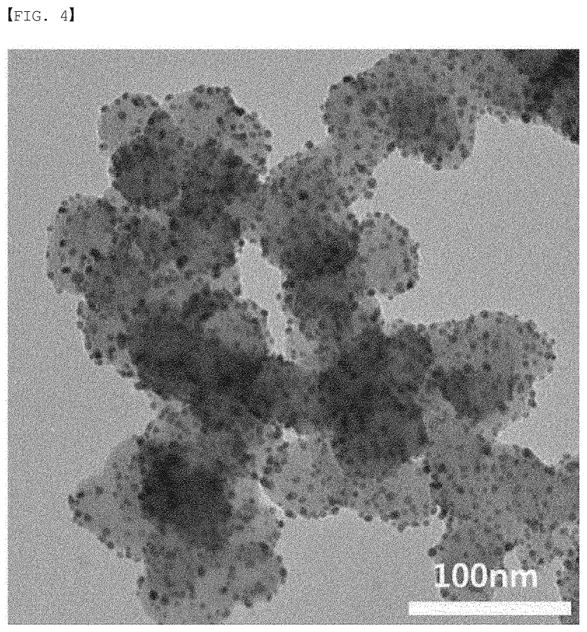

After dispersing the catalyst and a poly(4-styrenesulfonic acid) (Mw. 75,000) solution (polymer content in solution 18% by weight) into water in a weight ratio of 3:7, the result was stirred for 24 hours to form an intermediate between the nanoparticles. After that, the result was heat treated for 2 hours at 400° C. under the argon (Ar) to prepare Carrier-Nanoparticle Complex 1. The catalyst particle-supported Carrier-Nanoparticle Complex 1 was observed through a transmission electron microscope (TEM), and the result is shown in FIG. 4.

### Example 2

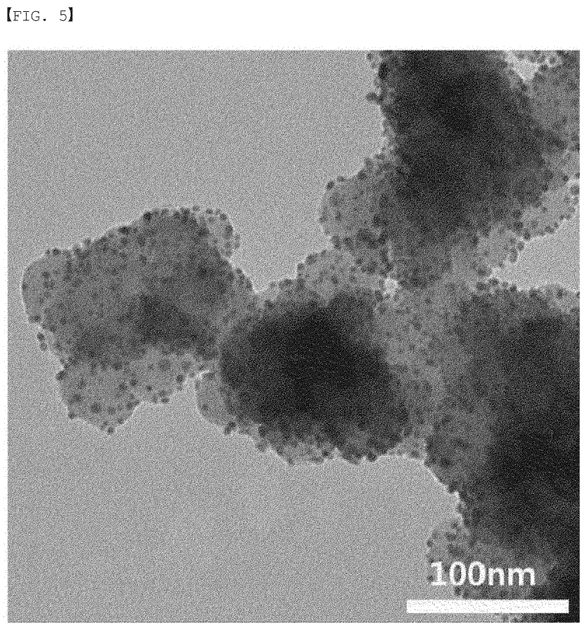

Carrier-Nanoparticle Complex 2 was prepared in the same manner as in Example 1 except that the heat treatment was performed at 600° C. instead of 400° C. The catalyst particle-supported Carrier-Nanoparticle Complex 2 was observed through a transmission electron microscope (TEM), and the result is shown in FIG. 5.

### Example 3

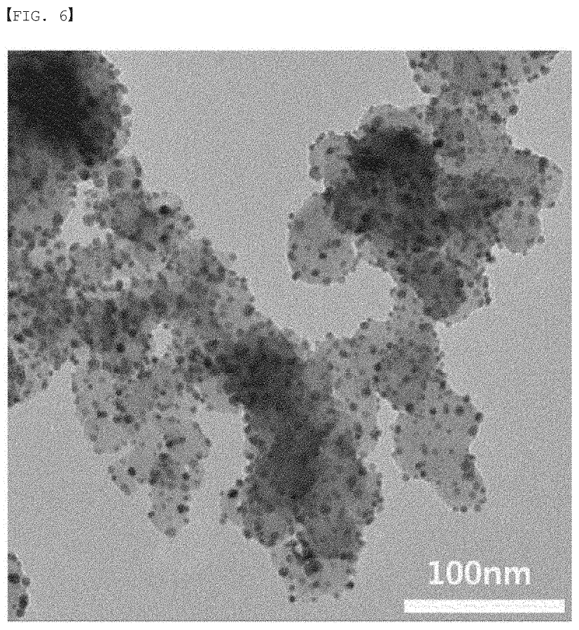

Carrier-Nanoparticle Complex 3 was prepared in the same manner as in Example 1 except that the heat treatment was performed at 800° C. instead of 400° C. The catalyst particle-supported Carrier-Nanoparticle Complex 3 was observed through a transmission electron microscope (TEM), and the result is shown in FIG. 6.

### Comparative Example 1

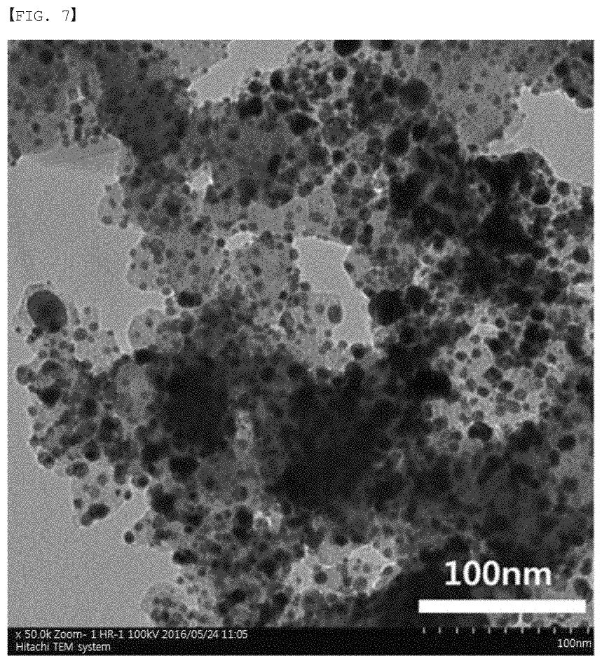

Carrier-Nanoparticle Complex 4 was prepared in the same manner as in Example 3 except that the intermediate was not formed. The catalyst particle-supported Carrier-Nanoparticle Complex 4 was observed through a transmission electron microscope (TEM), and the result is shown in FIG. 7.

### Comparative Example 2

After dissolving polyallylamine hydrochloride (PAH) (6 g) in water (1.5 L), carbon black (Vulcan XC-72R, manufactured by Cabot Corporation) (1.8 g) and KNO₃ (6 g) were introduced thereto, and the result was stirred for 24 hours. After that, solids were collected using centrifugation, and the solids were washed with distilled water and dried to obtain a PAH-coated carrier.

After dispersing the PAH-coated carrier (70 mg) into water (100 ml), K₂PtCl₄ (41.5 mg), nickel(II) acetate tetrahydrate (49.8 mg) and sodium citrate (294.1 mg) were added to the solution, and then dispersed. After that, while stirring the result in a water bath adjusted to 15° C., sodium borohydride (50 mg) and water (10 ml) were added thereto to reduce the metal precursor and support nickel-platinum alloy particles.

After that, ammonium phosphate (4 mg) was dissolved in distilled water, then aluminum nitrate (10.5 mg) was added thereto, and the result was stirred for 24 hours. The carrier (40 mg) was added thereto, and the result was sufficiently stirred to coat an aluminum phosphate-based compound on the carrier.

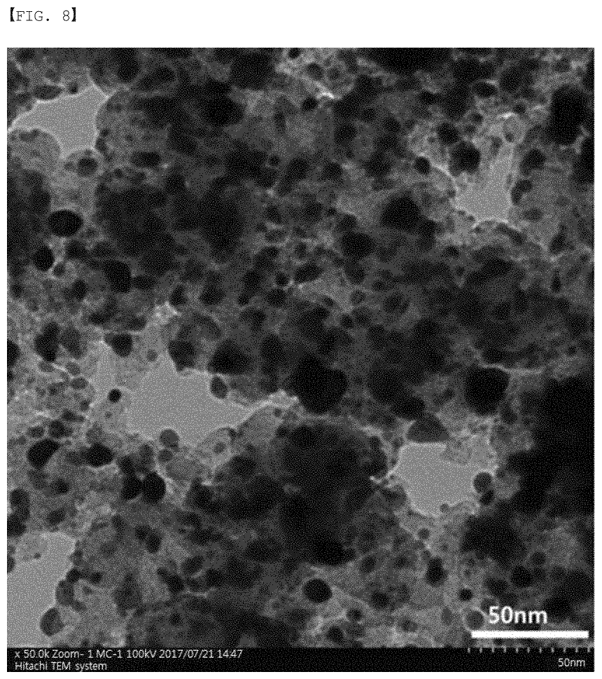

The catalyst was collected, and, under the argon (Ar) atmosphere, the temperature was raised to 200° C. at a temperature raising rate of 5° C./min, maintained for 2 hours, then raised again to 800° C., and maintained for 2 hours. The result was cooled, and the catalyst was collected to prepare Carrier-Nanoparticle Complex 5. The catalyst particle-supported Carrier-Nanoparticle Complex 5 was observed through a transmission electron microscope (TEM), and the result is shown in FIG. 8.

### Comparative Example 3

After dissolving polyallylamine hydrochloride (PAH) (6 g) in water (1.5 L), carbon black (Vulcan XC-72R, manufactured by Cabot Corporation) (1.8 g) and KNO₃ (6 g) were introduced thereto, and the result was stirred for 24 hours. After that, solids were collected using centrifugation, and the solids were washed with distilled water and dried to obtain a PAH-coated carrier.

After dispersing the PAH-coated carrier (70 mg) into water (100 ml), K₂PtCl₄ (41.5 mg), nickel(II) acetate tetrahydrate (49.8 mg) and sodium citrate (294.1 mg) were added to the solution, and then dispersed. After that, while stirring the result in a water bath adjusted to 15° C., sodium borohydride (50 mg) and water (10 ml) were added thereto to reduce the metal precursor and support nickel-platinum alloy particles.

After that, the prepared catalyst (40 mg) and polyallylamine hydrochloride (PAH) (60 mg) were dispersed into water (5 ml), and the result was stirred for 24 hours to coat PAH.

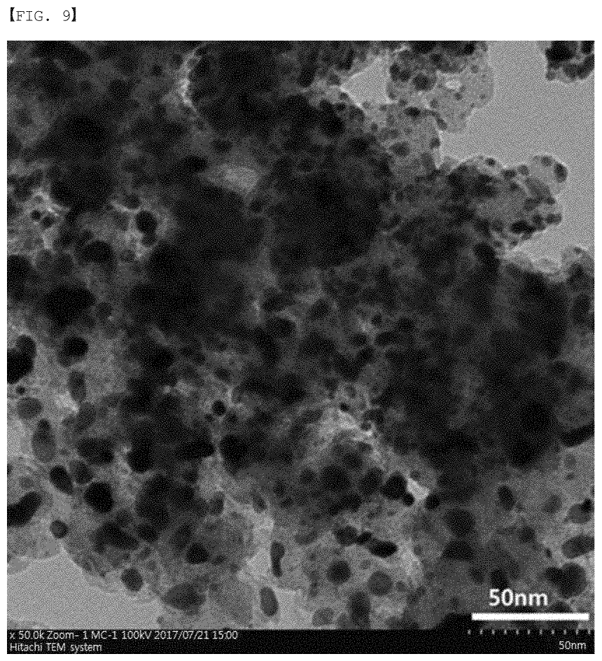

After that, the result was heat treated for 2 hours at 800° C. under the argon (Ar) atmosphere to prepare Carrier-Nanoparticle Complex 6. The catalyst particle-supported Carrier-Nanoparticle Complex 6 was observed through a transmission electron microscope (TEM), and the result is shown in FIG. 9.

### Comparative Example 4

A carrier-nanoparticle complex was prepared in the same manner as in Example 1 except that polyallylamine hydrochloride (PAH) and poly(4-styrenesulfonic acid) were coated once more. The prepared carrier-nanoparticle complex was observed through a transmission electron microscope (TEM), and the result is shown in FIG. 10.

Through this, catalyst particles being covered by PAH and poly(4-styrenesulfonic acid) was able to be identified.

### Experimental Results

### Experimental Example 1: Test on Suppression of Catalyst Particle Coarsening

Properties of the intermediate layer of the carrier-nanoparticle complex prepared in each of Examples 1 to 3 and Comparative Examples 1 to 3 are summarized in the following Table 1.

TABLE 1

| | | Heat | Suppression |
|---|---|---|---|
| | Constitution of | Treatment | of Catalyst |
| | Intermediate Layer | Temperature | Coarsening |
| Example 1 | Cation-Based Polymer | 400° C. | ◯ |
| | Electrolyte: PAH | | |
| | Anion-Based Polymer | | |
| | Electrolyte: Poly(4- | | |
| | Styrenesulfonic Acid) | | |
| Example 2 | Cation-Based Polymer | 600° C. | ◯ |
| | Electrolyte: PAH | | |
| | Anion-Based Polymer | | |
| | Electrolyte: Poly(4- | | |
| | Styrenesulfonic Acid) | | |
| Example 3 | Cation-Based Polymer | 800° C. | ◯ |
| | Electrolyte: PAH | | |
| | Anion-Based Polymer | | |
| | Electrolyte: Poly(4- | | |
| | Styrenesulfonic Acid) | | |
| Comparative | Intermediate Layer Not | 800° C. | X |
| Example 1 | Included | | |
| Comparative | Aluminum Phosphate- | 800° C. | X |
| Example 2 | Based Compound | | |
| Comparative | Cation-Based Polymer | 800° C. | X |
| Example 3 | Electrolyte: PAH | | |
| | Anion-Based Polymer | | |
| | Electrolyte: Not | | |
| | Included | | |

In the carrier-nanoparticle complexes of Examples 1 to 3 comprising an intermediate layer between supported nanoparticles, it was identified that coarsening, a phenomenon of catalyst particle growth, was effectively suppressed even when gone through a high temperature heat treatment process (FIGS. 4 to 6). This is due to the fact that the polymer electrolyte included in the intermediate layer comprises a cation-based polymer electrolyte and an anion-based polymer electrolyte strongly bonding to each other through electrostatic attraction, and particularly in Example 3, the intermediate layer has excellent crystallinity even under a high temperature since carbon having higher crystallinity is further included by carbonizing the polymer electrolyte at a high heat treatment temperature.

Through FIG. 7, it was identified that, in Comparative Example 1 with no intermediate layer present, the catalyst particle growth was not suppressed, and the catalyst particles grew large after heat treatment. Accordingly, it was identified that a catalyst particle growth may not be effectively suppressed when an intermediate layer was not included.

Through FIG. 8, it was identified that, in the carrier-nanoparticle complex according to Comparative Example 2, catalyst particle coarsening was not suppressed even with the intermediate layer. This is due to the fact that, in the intermediate layer of the carrier-nanoparticle complex of Comparative Example 2, the aluminum phosphate-based compound included in the intermediate layer did not bond strongly through electrostatic attraction. Accordingly, it was identified that catalyst particle growth may not be suppressed when disposing a simple compound as an intermediate layer.

Through FIG. 9, it was identified that, in the carrier-nanoparticle complex according to Comparative Example 3, catalyst particle coarsening was not suppressed even with the intermediate layer. Accordingly, it was identified that catalyst particle growth may not be suppressed when an intermediate layer comprises only a cationic polymer electrolyte since the bonding was not as strong as electrostatic attraction.

### Experimental Example 2: Test on Catalyst Performance

30 mg of the complex prepared in each of the examples and the comparative examples was mixed with 1.8 mL of iso-propyl alcohol and 257 mg of a Nafion solution (EW100, Nafion content in solution 5 wt %) to prepare an ink, and after coating the ink on one side surface (cathode surface) of a Nafion electrolyte membrane (Nafion membrane) using a spray apparatus, the other side surface (anode surface) was coated with 30 mg of a commercial catalyst (ALFA Aesar, 40% Pt/C).

After that, the result was hot pressed at 140° C. to prepare a membrane-electrode assembly.

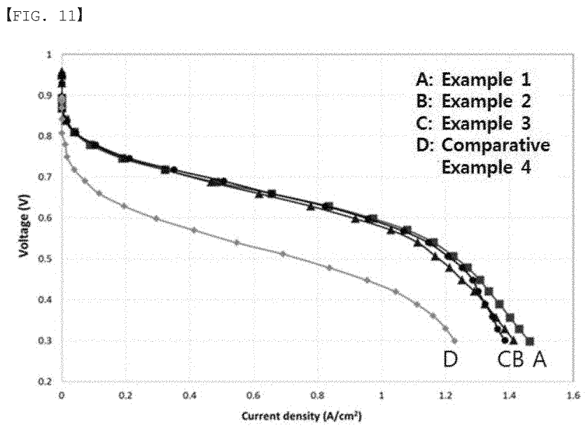

Using a square electrode having an area of 5 cm², performance of a single cell was measured under an 80° C. atmosphere while supplying H₂/air under a 100% humidity condition. Specifically, measurements were made by scanning the range of 0.3 V to 1.2 V with a step of 0.03 V, and performance was compared with an A/cm² value at 0.6 V. The results are shown in the following Table 2 and FIG. 11.

TABLE 2

| Type of Carrier-Nanoparticle | | |
|---|---|---|
| Complex Used in Membrane- | Humidity | Performance |
| Electrode Assembly | Condition | (A/cm² @0.6 V) |
| Example 1 | 100% Humidity | 0.97 |
| | Condition | |
| Example 2 | 100% Humidity | 0.92 |
| | Condition | |
| Example 3 | 100% Humidity | 0.96 |
| | Condition | |
| Comparative | 100% Humidity | 0.3 |
| Example 4 | Condition | |

From the above-described results, it was identified that cell performance was excellent when using the membrane-electrode assembly according to the example in a fuel cell. This is due to the fact that nanoparticle coarsening was suppressed by the intermediate layer provided between the catalyst particles. In other words, in the carrier-nanoparticle complexes of Examples 1 to 3, the catalyst particle surfaces were not completely covered by the intermediate layer, and the catalyst particles having a part of the surfaces exposed to the outside were sufficiently activated resulting in high performance.

On the other hand, it was identified that performance significantly declined in Comparative Example 4, and this is due to the fact surfaces of the catalyst particles contributing to activity were covered by the intermediate layer, and activity was not sufficiently expressed.

From the above-described results, it was identified that the carrier-nanoparticle complex according to the present disclosure exhibited excellent performance when used in a fuel cell since an intermediate layer was provided between the metal nanoparticles and nanoparticle activity was able to be maximized by a part of the metal nanoparticle being exposed to the outside while suppressing metal nanoparticle coarsening at a high temperature.

1. A method for preparing a carrier-nanoparticle complex,
wherein the carrier-nanoparticle complex comprises a carrier; a plurality of metal nanoparticles provided on the carrier; and an intermediate layer provided between some or all of the metal nanoparticles,
the method comprising:
forming a first polymer layer on a surface of the carrier by mixing the carrier and a first polymer electrolyte solution to provide a first polymer layer-formed carrier;
forming the metal nanoparticles on the first polymer layer by adding the first polymer layer-formed carrier and a metal precursor to a solvent; and
forming a polymer composite membrane on a part or all of a surface of the first polymer layer where the metal nanoparticles are not formed by mixing the first polymer layer and metal nanoparticles-formed carrier with a second polymer electrolyte solution to provide the carrier-nanoparticle complex,
wherein the first polymer electrolyte solution is an anion-based or a cation-based solution, and
the second polymer electrolyte solution has a charge opposite to the first polymer electrolyte solution,
wherein a part of a surface of the metal nanoparticles are exposed to the outside of the carrier-nanoparticle complex, and
the intermediate layer comprises a cation-based polymer electrolyte and an anion-based polymer electrolyte.

2. The method for preparing the carrier-nanoparticle complex of claim 1, comprising heat treating the polymer composite membrane after the forming of a polymer composite membrane.

3. The method for preparing the carrier-nanoparticle complex of claim 2, wherein the heat treating of the polymer composite membrane is performed at a temperature of 400° C. to 2000° C.

4. The method for preparing the carrier-nanoparticle complex of claim 2, wherein the heat treating of the polymer composite membrane is performed for 30 minutes to 120 minutes.

5. The method for preparing the carrier-nanoparticle complex of claim 2, further comprising post treatment after the heat treating of the polymer composite membrane.

6. The method for preparing the carrier-nanoparticle complex of claim 5, wherein the post treatment is heat treatment or acid treatment.
